(19) United States
(12) Patent Application Publication
(10) Pub. No.: US 2023/0341639 A1
(43) Pub. Date: Oct. 26, 2023

(54) OPTO-ELECTRIC HYBRID BOARD, OPTICAL-ELEMENT-MOUNTED OPTO-ELECTRIC HYBRID BOARD, AND METHOD OF MANUFACTURING OPTICAL-ELEMENT-MOUNTED OPTO-ELECTRIC HYBRID BOARD

(71) Applicant: NITTO DENKO CORPORATION, Ibaraki-shi, Osaka (JP)

(72) Inventors: Naoto Konegawa, Ibaraki-shi, Osaka (JP); Koji Ichinose, Ibaraki-shi, Osaka (JP); Seiki Teraji, Ibaraki-shi, Osaka (JP); Koya Osuka, Ibaraki-shi, Osaka (JP)

(73) Assignee: NITTO DENKO CORPORATION, Ibaraki-shi, Osaka (JP)

(21) Appl. No.: 18/026,671

(22) PCT Filed: Sep. 24, 2021
(86) PCT No.: PCT/JP2021/035049

§ 371 Date: Mar. 16, 2023

(30) Foreign Application Priority Data
Sep. 30, 2020 (JP) 2020-166242

(51) Int. Cl. G02B 6/42

(52) U.S. Cl. CPC G02B 6/4214; G02B 6/4293; G02B 6/428; G02B 6/4224; G02B 6/4244

(57) ABSTRACT

An opto-electric hybrid board capable of precisely mounting an optical element in a mirror position of an optical waveguide, there is provided an opto-electric hybrid board including: an electric circuit board having first and second surfaces and including terminals for mounting an optical element on the first surface; and an optical waveguide provided on the second surface of the electric circuit board and including a mirror for optical coupling to the optical element, wherein an alignment mark for identifying the position of an exit surface of light exiting via the mirror of the optical waveguide is formed on the first surface of the electric circuit board.

### TECHNICAL FIELD

The present disclosure relates to an opto-electric hybrid board, an optical-element-mounted opto-electric hybrid board, and a method of manufacturing the optical-element-mounted opto-electric hybrid board. More particularly, the present disclosure relates to an opto-electric hybrid board capable of mounting an optical element thereon, with optical axes of an optical element and an optical waveguide precisely aligned, an optical-element-mounted opto-electric hybrid board, and a method of manufacturing the optical-element-mounted opto-electric hybrid board.

### BACKGROUND ART

In recent electronic devices, opto-electric hybrid boards in which optical interconnect lines are used in addition to electrical interconnect lines have been widely used with an increase in the amount of transmission information. In optical-element-mounted opto-electric hybrid boards in which optical elements are mounted on the opto-electric hybrid boards, it has been required to transmit information between the optical elements and the opto-electric hybrid boards at a high throughput. To this end, it has been required that the optical elements are accurately positioned in the mounting of the optical elements and no misalignment occurs in optical coupling.

To meet such requirements, for example, PTL 1 discloses a method of manufacturing an optical-element-mounted optical waveguide module in which recessed portions formed by partially recessing a core layer of an optical waveguide are used as alignment marks serving as reference positions in the core layer, and an optical element is mounted on the optical waveguide with the use of the alignment marks as a reference for alignment.

However, the alignment marks in PTL 1, which are merely aligned with designed mirror positions, might deviate from the actual mirror positions depending on manufacturing conditions and the like. The partial formation of the alignment marks in the core layer causes another problem. Specifically, in the process of mounting optical elements on respective mirrors of an optical waveguide with the mirrors on both sides, the alignment marks cannot be recognized in an attempt to mount an optical element on one of the mirrors after another optical element is mounted on the other mirror.

### RELATED ART DOCUMENT

### Patent Document

PTL 1: JP-A-2013-174834

### SUMMARY

In view of the foregoing, the present disclosure provides: an opto-electric hybrid board capable of precisely mounting an optical element on a mirror position of an optical waveguide, with the optical axes of the optical element and the optical waveguide precisely aligned; an optical-element-mounted opto-electric hybrid board; and a method of manufacturing the optical-element-mounted opto-electric hybrid board in which optical elements are precisely mounted on respective mirror positions even when the opto-electric hybrid board includes an optical waveguide with the mirrors on both sides.

To accomplish the aforementioned object, the present disclosure provides the following [1] to [9].

[1] An opto-electric hybrid board comprising: an electric circuit board having first and second surfaces and including a terminal for mounting an optical element on the first surface; and an optical waveguide provided on the second surface of the electric circuit board and including a mirror for optical coupling to the optical element, wherein at least one alignment mark for identifying the position of an exit surface of light exiting via the mirror of the optical waveguide is formed on the first surface of the electric circuit board.

[2] The opto-electric hybrid board according to [1], wherein the alignment mark is made of metal or the same material as the mirror.

[3] The opto-electric hybrid board according to [1] or [2], wherein a distance between the area centroid of the alignment mark and the area centroid of the exit surface of light is within 5 mm.

[4] The opto-electric hybrid board according to any one of [1] to [3], wherein the at least one alignment mark includes a plurality of alignment marks.

[5] The opto-electric hybrid board according to [4], wherein the optical waveguide includes a plurality of mirrors, and a plurality of exit surfaces of light are present in the first surface of the electric circuit board, and wherein the alignment marks are formed in an arrangement such that a distance between the midpoint of an imaginary straight line connecting the area centroids of the respective exit surfaces of light and the midpoint of an imaginary straight line connecting the area centroids of the respective alignment marks is within 5 mm.

[6] The opto-electric hybrid board according to any one of [1] to [5], wherein the optical waveguide includes mirrors on both sides including a first mirror and a second mirror.

[7] An optical-element-mounted opto-electric hybrid board comprising: an opto-electric hybrid board as recited in any one of [1] to [6]; and an optical element mounted on the opto-electric hybrid board.

[8] A method of manufacturing an optical-element-mounted opto-electric hybrid board, comprising the steps of: preparing an opto-electric hybrid board as recited in any one of [1] to [5]; causing light to enter the optical waveguide of the opto-electric hybrid board to store the position of the exit surface of light in a computer, based on the alignment mark of the opto-electric hybrid board; and mounting an optical element on the exit surface of light, based on information stored in the computer.

[9] A method of manufacturing an optical-element-mounted opto-electric hybrid board, comprising the steps of: preparing an opto-electric hybrid board as recited in [6]; causing light to enter the optical waveguide from the first mirror side of the opto-electric hybrid board to store the position of an exit surface of light on the second mirror side in a computer, based on the alignment mark of the opto-electric hybrid board; causing light to enter the optical waveguide from the second mirror side of the opto-electric hybrid board to mount an optical element on an exit surface of light on the first mirror side; and mounting an optical element on the exit surface of light on the second mirror side, based on information stored in the computer.

The present inventors have diligently made studies to solve the aforementioned problem. As a result, the present inventors have found that the optical connection loss between the opto-electric hybrid board and the optical element is reduced when the optical element is mounted so that the optical axis of a light-receiving surface of the optical element coincides with the area centroid of the exit surface of light exiting via the mirror of the optical waveguide.

In the opto-electric hybrid board of the present disclosure, the alignment mark for identifying the position of the exit surface of light exiting via the mirror of the optical waveguide is formed on the surface of the electric circuit board having the terminal. Thus, the use of the alignment mark allows the mounting of the optical element, with the optical axes of the optical element and the optical waveguide precisely aligned.

In the method of manufacturing the optical-element-mounted opto-electric hybrid board of the present disclosure, the optical element is mounted on the opto-electric hybrid board, with the optical axes of the optical element and the optical waveguide precisely aligned. This provides the optical-element-mounted opto-electric hybrid board capable of transmitting information at a higher throughput.

### BRIEF DESCRIPTION OF DRAWINGS

FIG. 1 is a plan view schematically showing an opto-electric hybrid board according to one embodiment of the present disclosure.

FIG. 2 is a view illustrating main components of the aforementioned opto-electric hybrid board from a lateral direction.

FIG. 3 is an exploded view of main components of the aforementioned opto-electric hybrid board.

FIGS. 4A, 4B, and 4C are views illustrating a procedure for identifying the position of an exit surface of light of the aforementioned opto-electric hybrid board.

FIG. 5 is a view illustrating the position of an alignment mark of the aforementioned opto-electric hybrid board.

FIGS. 6A to 6D are views illustrating steps of manufacturing the aforementioned opto-electric hybrid board.

FIGS. 7A and 7B are views illustrating steps of manufacturing the aforementioned opto-electric hybrid board.

FIGS. 8A and 8B are views illustrating steps of manufacturing the aforementioned opto-electric hybrid board.

FIG. 9 is a view illustrating a modification of the aforementioned opto-electric hybrid board.

FIG. 10A is a view illustrating a step of manufacturing an optical-element-mounted opto-electric hybrid board according to one embodiment of the present disclosure; and FIG. 10B is a plan view showing a state of the opto-electric hybrid board in this step.

FIG. 11A is a view illustrating a step of manufacturing the aforementioned optical-element-mounted opto-electric hybrid board; and FIG. 11B is a plan view showing a state of the opto-electric hybrid board in this step.

FIG. 12A is a view illustrating a step of manufacturing the aforementioned optical-element-mounted opto-electric hybrid board; and FIG. 12B is a plan view of the optical-element-mounted opto-electric hybrid board in this step.

### DESCRIPTION OF EMBODIMENTS

In describing the present disclosure, specific examples will be given. However, the present disclosure is not limited to the following description without departing from the spirit and scope of the present disclosure, and may be implemented with appropriate changes.

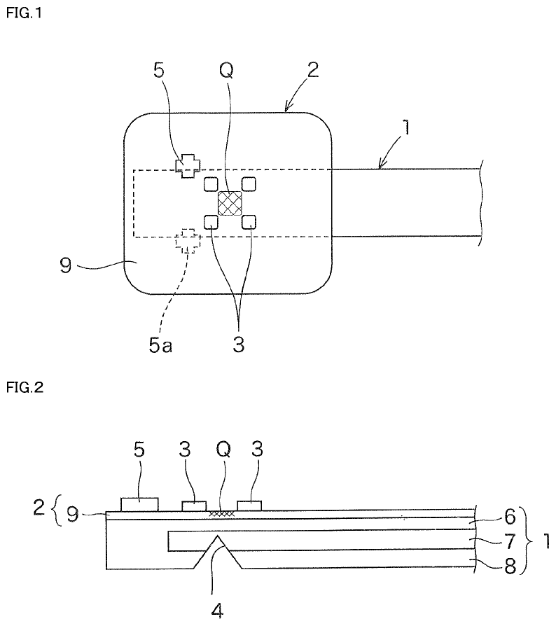

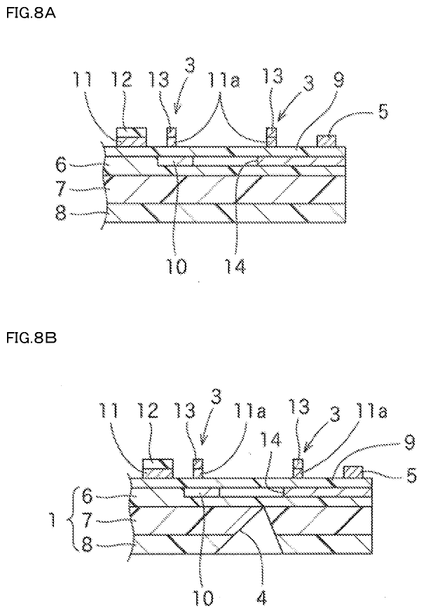

FIG. 1 is a plan view schematically showing an opto-electric hybrid board according to one embodiment of the present disclosure. FIG. 2 is a view illustrating main components of the opto-electric hybrid board as seen from a lateral direction. The aforementioned opto-electric hybrid board includes an optical waveguide 1 and an electric circuit board 2 which are stacked in a thickness direction. An alignment mark 5 for identifying the position of an exit surface Q of light exiting via a mirror 4 of the aforementioned optical waveguide 1 is formed in a surface of the opto-electric hybrid board which has terminals 3. A metal layer for reinforcement is arranged in portions between the optical waveguide 1 and the electric circuit board 2 where a certain level of strength is required, such as portions on which various elements are to be mounted (with reference to FIG. 8B), but is not shown (it may also be omitted from subsequent figures in some cases).

[Optical Waveguide 1]

The optical waveguide 1 includes an under cladding layer 6, a core 7 for an optical path formed in a predetermined pattern on a front surface of the under cladding layer 6 (a lower surface as seen in FIG. 2), and an over cladding layer 8 integral with the front surface of the under cladding layer 6 while covering the core 7. The core 7 has a refractive index higher than those of the under cladding layer 6 and the over cladding layer 8.

Examples of materials for the formation of the under cladding layer 6, the core 7, and the over cladding layer 8 include transparent resins such as epoxy resin and acrylic resin.

A portion of the opto-electric hybrid board corresponding to a location where an optical element is to be mounted is in the form of an inclined surface at 45 degrees with respect to the direction of extension of the core 7. This inclined surface serves as the mirror 4 that is a light reflecting surface functioning to change the direction of light propagated in the core 7 by 90 degrees to cause the light to enter a light-receiving portion of the optical element or to change the direction of light exiting a light-emitting portion of the optical element by 90 degrees to cause the light to enter the core 7.

The optical waveguide 1 has a thickness generally in the range of 20 to 200 μm, including the thicknesses of the under cladding layer 6, the core 7, and the over cladding layer 8. The core 7 has a width generally in the range of 20 to 100 μm.

[Electric Circuit Board 2]

The electric circuit board 2 is configured such that an electrical interconnect line (not shown), the terminals 3 for use in mounting an optical element, and the like are formed on a front surface of an insulative layer 9 having transparency and made of a resin such as polyimide. The aforementioned electrical interconnect line is generally insulated and protected by a coverlay (not shown) made of the same resin as the insulative layer 9, such as polyimide. A front surface of the terminals 3 not covered with the coverlay is generally covered with an electroplated layer made of gold, nickel, or the like.

The alignment mark 5 for identifying the position of the exit surface Q of light is formed on the surface of the electric circuit board 2 which has the terminals 3. This is a striking feature of the present disclosure.

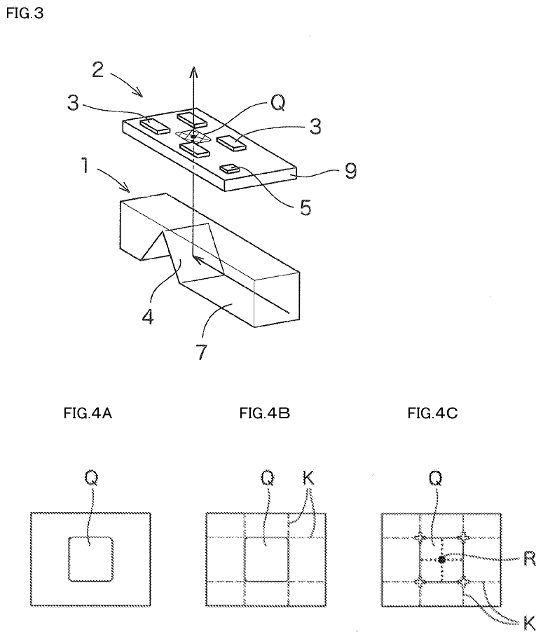

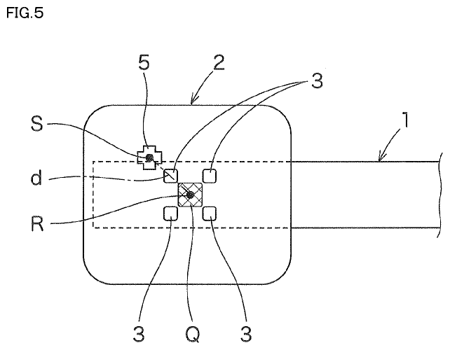

As shown in FIG. 3, the exit surface Q of light appears when light propagated in the core 7 in a direction indicated by an arrow changes its direction by 90 degrees and is then transmitted through the insulative layer 9. As shown in FIG. 4A, the exit surface Q of light, which is a region in which light reflected by the mirror 4 appears, appears in substantially the same shape as the mirror 4, which is typically a rectangular shape.

The area centroid of the exit surface Q of light is obtained in a manner to be described below. As shown in FIG. 4B, approximate straight lines K are drawn along boundary lines of the region appearing in the rectangular shape. Then, as shown in FIG. 4C, the area centroid of the region surrounded by the approximate straight lines K is calculated and determined as the area centroid R of the exit surface Q of light. The area centroid R is calculated, for example, by acquiring an image of the exit surface Q, obtaining a histogram of the entire image, performing a binarization process or the like, and then obtaining an average value for position coordinates of the image subjected to the process.

The alignment mark 5 is preferably formed in the vicinity of the exit surface Q of light because the alignment mark 5 serves as a reference for identifying the position of the exit surface Q of light exiting via the mirror 4 of the optical waveguide 1. For example, as shown in FIG. 5, the distance d between the area centroid S of the alignment mark 5 and the area centroid R of the exit surface Q of light is preferably within 5 mm and more preferably not greater than 3 mm. The distance d may be measured, for example, using an optical microscope or a three-dimensional dimension measurement machine.

A material for the formation of the alignment mark 5 is not particularly limited, but is preferably metal and more preferably the same metal as the aforementioned electrical interconnect line. When the same metal as the aforementioned electrical interconnect line is used, the alignment mark 5 may be formed, for example, at the same time that the aforementioned electrical interconnect line is formed.

The alignment mark 5 has a thickness preferably in the range of 0.3 to 50 μm and more preferably in the range of 0.5 to 2 μm. When the thickness of the alignment mark 5 is within the aforementioned range, the alignment mark is excellent in terms of productivity.

The alignment mark 5 preferably has a symmetrical shape. The area of the alignment mark 5 is preferably not less than 5 μm² and more preferably in the range of 5 to 50 μm². When the size of the alignment mark 5 is within the aforementioned range, the alignment mark 5 is excellent in terms of improved recognizability. The alignment mark 5 may have any shape so long as the shape is suitable for identifying the position of the exit surface Q of light. However, the alignment mark 5 is preferably cross-shaped as seen in plan view, which makes it easier to calculate the area centroid S thereof.

Next, a method of manufacturing the aforementioned opto-electric hybrid board will be described.

### [Formation of Electric Circuit Board 2]

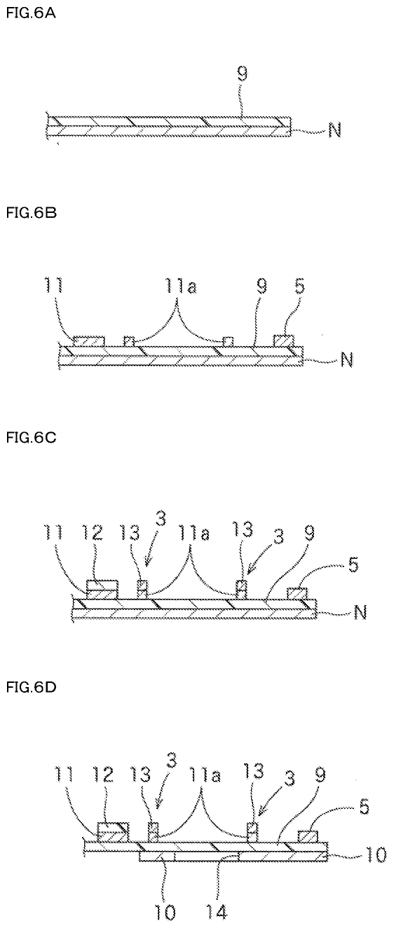

First, a metal sheet material N (with reference to FIG. 6) for the formation of a metal layer 10 for reinforcement (with reference to FIG. 6D) to be provided between the optical waveguide 1 and the electric circuit board 2 is prepared. Examples of a material for the formation of the metal sheet material N include stainless steel and 42 alloy (an alloy of iron and nickel, wherein a content of the nickel is 42%). In particular, stainless steel is preferable from the viewpoint of dimensional accuracy and the like. The metal sheet material N (the metal layer 10) has a thickness in the range of 5 to 100 μm, for example.

Next, as shown in FIG. 6A, a photosensitive insulating resin is applied to a front surface of the metal sheet material N to form the insulative layer 9 having a predetermined pattern by a photolithographic process or the like. Examples of a material for the formation of the insulative layer 9 include: synthetic resins such as polyimide, polyether nitrile, polyether sulfone, polyethylene terephthalate, polyethylene naphthalate, and polyvinyl chloride; and silicone sol-gel materials. The insulative layer 9 has a thickness in the range of 1 to 100 μm, for example.

Next, as shown in FIG. 6B, the aforementioned electrical interconnect line 11, mounting pads 11a, and the alignment mark 5 are formed by a semi-additive process or a subtractive process, for example. The electrical interconnect line 11 and the mounting pads 11a have a thickness preferably in the range of 1 to 30 μm, for example.

Next, as shown in FIG. 6C, a photosensitive insulating resin including a polyimide resin or the like is applied to a portion of the electrical interconnect line 11 to thereby form a coverlay 12 by a photolithographic process. Then, the terminals 3 are formed by covering a front surface of the mounting pads 11a with an electroplated layer 13. In this manner, the electric circuit board 2 (with reference to FIG. 2) is formed on the front surface of the metal sheet material N. The coverlay 12 has a thickness preferably in the range of 1 to 30 μm, for example. This coverlay 12 is not shown in FIG. 1 and the like.

The alignment mark 5 need not be formed at the same time as the electrical interconnect line 11 and the mounting pads 11a, but may be formed separately using materials different from the materials of the electrical interconnect line 11 and the mounting pads 11a.

[Formation of Metal Layer 10]

Thereafter, as shown in FIG. 6D, etching or the like is performed on the metal sheet material N to impart a predetermined shape including a through hole 14 to the metal sheet material N. In this manner, the metal sheet material N is formed into the metal layer 10. The metal layer 10 is not shown in FIG. 1 and the like.

[Formation of Optical Waveguide 1]

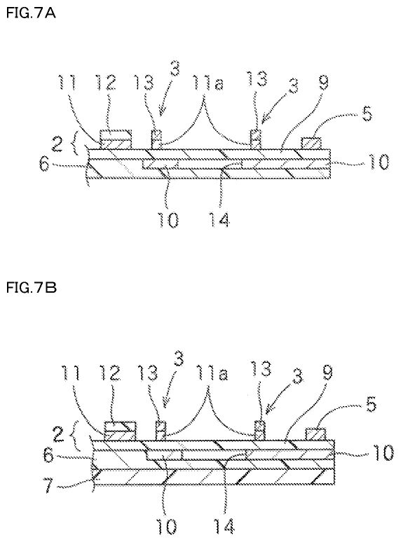

For the formation of the optical waveguide 1 on a back surface of the electric circuit board 2, a photosensitive resin which is a material for the formation of the under cladding layer 6 is initially applied to the back surface (the lower surface as seen in the figure) of the electric circuit board 2, and is formed into the under cladding layer 6 by a photolithographic process, as shown in FIG. 7A. The under cladding layer 6 has a thickness (a thickness as measured from a back surface of the metal layer 10) in the range of 1 to 80 μm, for example. It should be noted that the back surface of the electric circuit board 2 is positioned to face upward when the optical waveguide 1 is formed (when the aforementioned under cladding layer 6, the core 7 to be described later, and the over cladding layer 8 to be described later are formed).

Next, as shown in FIG. 7B, a photosensitive dry film which is a material for the formation of the core 7 is laminated to or a photosensitive resin is applied to the front surface (the lower surface as seen in the figure) of the under cladding layer 6 to form the core 7 by a photolithographic process. The core 7 has a thickness in the range of 2 to 80 μm, for example.

Then, as shown in FIG. 8A, a material for the formation of the over cladding layer 8 is applied to the front surface (the lower surface as seen in the figure) of the under cladding layer 6 so as to cover the core 7 to form the over cladding layer 8 by a photolithographic process. The over cladding layer 8 has a thickness [a thickness as measured from the top surface (the lower surface as seen in the figure) of the core 7] in the range of 2 to 50 μm, for example. An example of the material for the formation of the over cladding layer 8 includes a photosensitive resin similar to that for the under cladding layer 6.

Thereafter, as shown in FIG. 8B, a specific portion of the core 7 together with the under cladding layer 6 and the over cladding layer 8 is formed into an inclined surface inclined at 45 degrees with respect to the direction of extension (the longitudinal direction) of the core 7, for example, by dicing or laser machining. The specific portion of the core 7 which is positioned at the inclined surface serves as the mirror 4 (light reflecting surface). In this manner, the optical waveguide 1 including the mirror 4 is formed on the back surface of the metal layer 10. Thus, the opto-electric hybrid board of the present disclosure is provided.

According to this configuration, the alignment mark 5 for identifying the position of the exit surface Q of light exiting via the mirror 4 of the optical waveguide 1 is formed on the surface of the opto-electric hybrid board which has the terminals 3. This allows the mounting of an optical element while accurately identifying the position of the exit surface Q of light. Thus, when an optical element is mounted on the opto-electric hybrid board of the present disclosure, an optical-element-mounted opto-electric hybrid board is provided which is capable of transmitting information at a higher throughput.

Although the single mirror 4 of the optical waveguide 1 is formed in the opto-electric hybrid board in the aforementioned embodiment, a plurality of mirrors 4 may be formed. In that case, the alignment mark 5 is required only to identify the position of the exit surface Q of light exiting via any one of the mirrors 4. Preferably, the area centroid S of the alignment mark 5 is positioned so that the distance d from the area centroid R of the exit surface Q of light exiting via the closest one of the mirrors 4 thereto is within 5 mm.

Although the single alignment mark 5 is formed on the opto-electric hybrid board in the aforementioned embodiment, a plurality of alignment marks 5 may be formed. The formation of the plurality of alignment marks 5 allows more precise identification of the position of the exit surface Q of light. It is preferred that the plurality of alignment marks 5 are formed, in particular, on the opto-electric hybrid board which includes the plurality of mirrors 4 formed therein and accordingly has a plurality of exit surfaces Q of light.

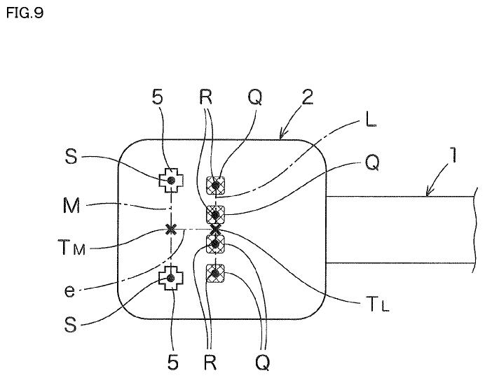

In the opto-electric hybrid board having the plurality of exit surfaces Q of light, as shown in FIG. 9, it is preferred that the plurality of alignment marks 5 are formed in an arrangement such that the distance e between the midpoint T_{L} of an imaginary straight line L connecting the area centroids R of the respective exit surfaces Q of light and the midpoint T_{M} of an imaginary straight line M connecting the area centroids S of the respective alignment marks {5} is within 5 mm, preferably within 3 mm, and more preferably within 1.5 mm.

Next, description will be given on a method of manufacturing an optical-element-mounted opto-electric hybrid board in which what is called a double-mirror optical waveguide having the mirror 4 on each of the two end edges is used as the optical waveguide 1 in the opto-electric hybrid board of the present disclosure and an optical element is mounted in each of the locations corresponding to the mirrors on both sides.

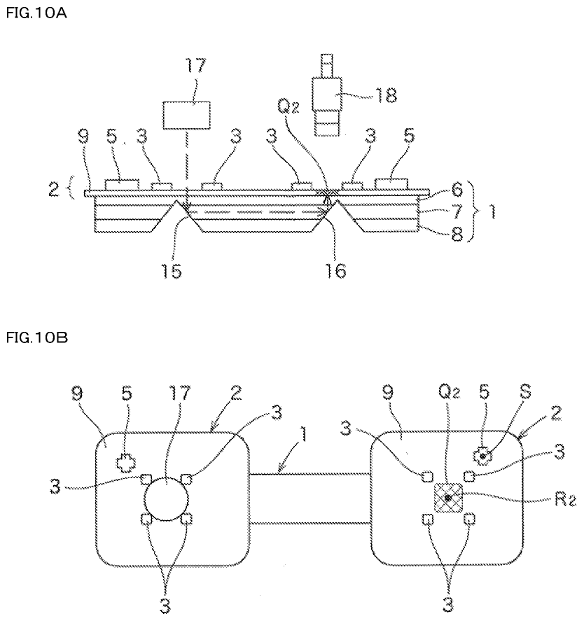

First, the opto-electric hybrid board of the present disclosure which has the optical waveguide 1 including a first mirror 15 and a second mirror 16 is prepared (with reference to FIGS. 10A and 10B).

Then, as shown in FIGS. 10A and 10B, light from a light source 17 on the first mirror 15 side of the opto-electric hybrid board is caused to enter the optical waveguide 1 as indicated by an arrow, and the position of an exit surface Q₂ of light exiting via the second mirror 16 is stored in a computer, based on the alignment marks 5. An exemplary method of storing the position in the computer includes: photographing the exit surface Q₂ of light and the alignment mark 5 in the vicinity thereof on a single screen by means of a camera 18; causing the computer to capture the image data; calculating area centroids; and storing the distance and direction from the area centroid S of the aforementioned alignment mark 5 to the area centroid R₂ of the exit surface Q₂ of light in the computer (position coordinate storage).

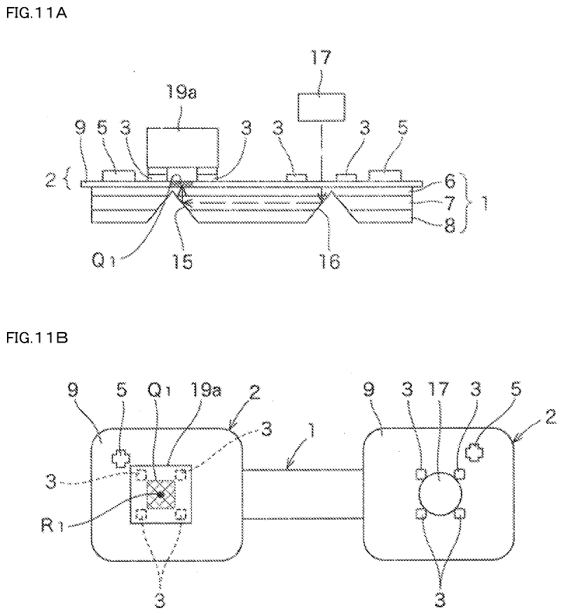

Next, as shown in FIGS. 11A and 11B, light from the light source 17 on the second mirror 16 side of the opto-electric hybrid board is caused to enter the optical waveguide 1 as indicated by an arrow, and a light-receiving element 19a is mounted on an exit surface Q₁ of light exiting via the first mirror 15 so that the area centroid R₁ of the exit surface Q₁ of light and the area centroid (optical axis) of a light-receiving surface of the light-receiving element 19a coincide with each other.

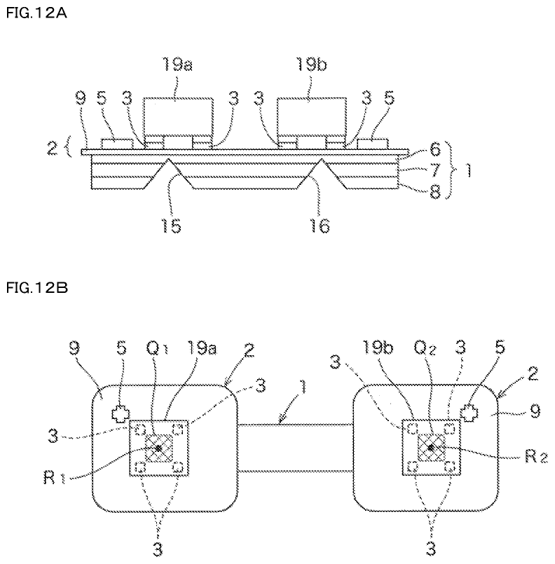

Then, as shown in FIGS. 12A and 12B, a light-receiving element 19b is mounted on the exit surface Q₂ of light on the second mirror 16 side so that the area centroid R₂ of the exit surface Q₂ of light and the area centroid (optical axis) of a light-receiving surface of the light-receiving element 19b coincide with each other, based on the information stored in the aforementioned computer. This provides the optical-element-mounted opto-electric hybrid board with the optical axes precisely aligned. If it is difficult to grasp the optical axes of the aforementioned light-receiving elements, the mounting may be performed by considering the area centroids of the light-receiving surfaces of the light-receiving elements as the optical axes.

Although the alignment marks 5 are provided in corresponding relation to the first and second mirrors 15 and 16 in the aforementioned embodiment, only one of the alignment marks 5 may be provided. However, when the alignment marks 5 corresponding to the respective mirrors on both sides are provided, it is more convenient in that either optical element can be mounted first.

The mounting of the optical elements on the opto-electric hybrid board including the optical waveguide 1 with the mirrors on both sides is described in the aforementioned embodiment. However, the mounting of an optical element on the opto-electric hybrid board including the optical waveguide 1 having any one of the mirrors 4 may be performed in the same manner. In this case, however, the step of storing the position of the exit surface Q of light in the computer is not necessary, but it is only necessary that light is caused to enter the optical waveguide 1 and the optical element is mounted on the exit surface Q of light exiting via the mirror 4 so that the area centroid R of the exit surface Q of light and the area centroid (optical axis) of a light-receiving surface of the optical element coincide with each other.

Further, the optical waveguide 1 includes the single core 7 and the single mirror 4 formed therein in the aforementioned embodiment. However, the mounting of optical elements may be performed in the same manner when a plurality of cores 7 are arranged and a plurality of mirrors 4 are formed (with reference to FIG. 9).

### EXAMPLES

Although the present disclosure will be described hereinafter in further detail using examples, the examples may be modified as appropriate without departing from the spirit and scope of the present disclosure. Therefore, the scope of the present disclosure should not be interpreted as limited by the specific examples illustrated below.

Prior to the production of examples and a comparative example, materials to be described below were first prepared.

An opto-electric hybrid board including the exit surface Q of light having a substantially rectangular shape with a width of 50 μm and a length of 50 μm was used as the opto-electric hybrid board shown in FIG. 1. An opto-electric hybrid board including the exit surfaces Q₁ and Q₂ of light each having a substantially rectangular shape with a width of 50 μm and a length of 50 μm and spaced 25 μm apart from each other was used as the opto-electric hybrid board shown in FIGS. 10A, 10B, 11A, 11B, 12A, and 12B. A vertical cavity surface emitting laser was used for the entrance of light. Photodiodes were prepared as the light-receiving elements 19a and 19b.

### Example 1

Like the opto-electric hybrid board shown in FIG. 1, an opto-electric hybrid board was produced which had the single exit surface Q of light exiting via the mirror 4 of the optical waveguide 1 and in which the single alignment mark 5 for identifying the position of this exit surface Q of light was formed in a position such that the distance d between the area centroid S of the alignment mark 5 and the area centroid R of the exit surface Q of light was 5 mm, as shown in FIG. 5.

Then, light was caused to enter the optical waveguide 1 of this opto-electric hybrid board, and the position of the exit surface Q of the light was stored in a computer, based on the alignment mark 5. Based on the information stored in the computer, a light-receiving element was mounted in an arrangement such that the area centroid R of the exit surface Q of light coincided with the optical axis of the light-receiving element. Thus, an optical-element-mounted opto-electric hybrid board was produced.

### Example 2

An opto-electric hybrid board and an optical-element-mounted opto-electric hybrid board were produced in the same manner as in Example 1 except that an alignment mark 5a indicated by broken lines in FIG. 1 was formed in a position such that the distance d between the area centroid S of the alignment mark 5a and the area centroid R of the exit surface Q of light was 5 mm. That is, the opto-electric hybrid board in Example 2 has the alignment marks 5 and 5a.

### Example 3

An opto-electric hybrid board and an optical-element-mounted opto-electric hybrid board were produced in the same manner as in Example 2 except that the distance d between the area centroid S of each of the alignment marks 5 and 5a and the area centroid R of the exit surface Q of light was 3 mm.

### Example 4

Like the opto-electric hybrid board shown in FIG. 9, an opto-electric hybrid board was produced which had four exit surfaces Q of light exiting via the mirrors 4 of the optical waveguide 1 and in which two alignment marks 5 for identifying the positions of the exit surfaces Q of light were formed in an arrangement such that the distance e between the midpoint T_{L} of the imaginary straight line L connecting the area centroids R of the four respective exit surfaces Q of light and the midpoint T_{M} of the imaginary straight line M connecting the area centroids S of the two respective alignment marks 5 was 5 mm.

Then, light was caused to enter a plurality of optical waveguides 1 of this opto-electric hybrid board, and the positions of the exit surfaces Q of the light were stored in the computer, based on the alignment marks 5. Based on the information stored in the computer, light-receiving elements were mounted in an arrangement such that the area centroids R of the respective exit surfaces Q of light coincided with the optical axes of the respective light-receiving elements. Thus, an optical-element-mounted opto-electric hybrid board was produced.

### Example 5

An opto-electric hybrid board and an optical-element-mounted opto-electric hybrid board were produced in the same manner as in Example 4 except that the two alignment marks were formed in an arrangement such that the distance e between the midpoint T_{L} and the midpoint T_{M} was 3 mm.

### Example 6

An opto-electric hybrid board was produced in the same manner as in Example 5 except that the opto-electric hybrid board had the optical waveguide 1 having mirrors on both sides, i.e., a first mirror and a second mirror. Then, the method illustrated in FIGS. 10A, 10B, 11A, 11B, 12A, and 12B was used to mount the light-receiving elements 19a and 19b on the aforementioned opto-electric hybrid board. Specifically, light from the first mirror 15 side of the opto-electric hybrid board was caused to enter the optical waveguide 1, and the position of the exit surface Q₂ of light exiting on the second mirror 16 side was stored in the computer, based on the alignment marks 5. Next, light from the second mirror 16 side of the opto-electric hybrid board was caused to enter the optical waveguide 1, and the light-receiving element 19a was mounted on the exit surface Q₁ of light on the first mirror 15 side so that the area centroid R₁ of the exit surface Q₁ of light and the optical axis of the light-receiving element 19a coincided with each other. Further, the light-receiving element 19b was mounted on the exit surface Q₂ of light on the second mirror 16 side so that the area centroid R₂ of the exit surface Q₂ of light and the optical axis of the light-receiving element 19b coincided with each other, based on the information stored in the aforementioned computer. Thus, an optical-element-mounted opto-electric hybrid board was produced.

### Comparative Example 1

An optical-element-mounted opto-electric hybrid board was produced in the same manner as in Example 1 except that the position of the exit surface Q of the light was not stored in the computer, based on the alignment mark 5, but the light-receiving element was simply mounted using the alignment mark 5 as an indicator.

The “amount of misalignment” and “loss of optical connection” were measured for the optical-element-mounted opto-electric hybrid boards produced in Examples 1 to 6 and Comparative Example 1 in a manner to be described below, and were listed together in TABLE 1 below.

[Amount of Misalignment]

A CNC image measurement system (NEXIV available from Nikon Corporation) was used to measure the position of a transmission channel of the light-receiving element mounted on each of the opto-electric hybrid boards, thereby identifying the position of the optical axis center thereof. Then, how far the position of the optical axis center was apart from the position of the area centroid R of the exit surface Q of light was calculated, and the calculated value was expressed as the amount of misalignment (μm).

When each of the opto-electric hybrid boards had a plurality of exit surfaces Q of light, how far the midpoint T_{L} of the imaginary straight line L connecting the area centroids R of the respective exit surfaces Q of light and the midpoint of an imaginary straight line connecting the optical axis centers of the respective light-receiving elements were apart from each other was calculated, and the calculated value was expressed as the amount of misalignment (μm).

[Loss of Optical Connection]

Losses in optical connection between the opto-electric hybrid boards and the light-receiving elements were measured using an optical tester (OPT-002 available from Synergy Optosystems Co., Ltd.) which was a measurement machine for measuring the shape of an optical waveguide and optical losses. Specifically, a light source was placed in a position where test light is allowed to enter the mirror 4 of the optical waveguide 1, and a light-receiving portion (CCD) of the aforementioned optical tester was mounted as each of the light-receiving elements. Prior to the measurement, the amount of light at the exit surface Q of light was previously measured and used as a reference light amount. Then, the loss (dB) of optical connection was calculated from the amount of light (light intensity) measured at the light-receiving element (the light-receiving portion of the optical tester) in each of the examples and comparative example in the light of the aforementioned reference light amount (light intensity). When each of the opto-electric hybrid boards had a plurality of exit surfaces Q, the average thereof was used as that value.

TABLE 1

| | The | The | | | | Loss of |
|---|---|---|---|---|---|---|
| | number of | number of | Distance between exit | Mirrors | Amount of | optical |
| | exit | alignment | surfaces Q and alignment | on both | misalignment | connection |
| | surfaces Q | marks | marks (mm) | sides | (μm) | (dB) |
| Ex. 1 | 1 | 1 | 5 | No | 8 | 1 |
| Ex. 2 | 1 | 2 | 5 | No | 7 | 0.5 |
| Ex. 3 | 1 | 2 | 3 | No | 6 | 0.3 |
| Ex. 4 | 4 | 2 | (Distance between | No | 5.5 | 0.2 |
| | | | midpoints of imaginary lines) 5 | | | |
| Ex. 5 | 4 | 2 | (Distance between | No | 5 | 0.1 |
| | | | midpoints of imaginary lines) 3 | | | |
| Ex. 6 | 4 | 2 | (Distance between | Yes | 5 | 0.1 |
| | | | midpoints of imaginary lines) 3 | | | |
| Comp. | 1 | 1 | — | No | 20 | 1.7 |
| Ex. 1 | | | | | | |

The aforementioned results showed that each of the opto-electric hybrid boards in Examples 1 to 6 suppressed the optical connection loss when the optical element was mounted, and achieved the accurate positioning of the optical element. In particular, it was found that the opto-electric hybrid board in Example 6 suppressed the optical connection loss on both sides and achieved the accurate positioning of the optical elements, despite the fact that the opto-electric hybrid board had the mirrors on both sides.

In contrast, it was found that the opto-electric hybrid board in Comparative Example 1 had a large amount of misalignment when the optical element was mounted and was not improved in optical connection loss.

Although specific forms in the present disclosure have been described in the aforementioned examples, the aforementioned examples should be considered as merely illustrative and not restrictive. It is contemplated that various modifications evident to those skilled in the art could be made without departing from the scope of the present disclosure.

The opto-electric hybrid board of the present disclosure, in which the optical element is precisely mounted on the mirror of the optical waveguide, is preferably used for the optical-element-mounted opto-electric hybrid board which is required to transmit information at a high throughput. The method of manufacturing the optical-element-mounted opto-electric hybrid board of the present disclosure, in which the optical elements are precisely mounted for the mirrors on both sides of the opto-electric hybrid board including the optical waveguide with the mirrors on both sides, is preferably used for the manufacture of the optical-element-mounted opto-electric hybrid board which is required to transmit information at a high throughput.

### REFERENCE SIGNS LIST

1 Optical waveguide
2 Opto-electric hybrid board
3 Terminals
4 Mirror
5 Alignment mark
Q Exit surface of light

1. An opto-electric hybrid board comprising:
an electric circuit board having first and second surfaces and including a terminal for mounting an optical element on the first surface; and
an optical waveguide provided on the second surface of the electric circuit board and including a mirror for optical coupling to the optical element,
wherein at least one alignment mark, for identifying the position of an exit surface of light exiting via the mirror of the optical waveguide is formed on the first surface of the electric circuit board.

2. The opto-electric hybrid board according to claim 1,
wherein the alignment mark is made of metal or the same material as the mirror.

3. The opto-electric hybrid board according to claim 1,
wherein a distance between the area centroid of the alignment mark and the area centroid of the exit surface of light is within 5 mm.

4. The opto-electric hybrid board according to claim 1,
wherein the first surface includes a plurality of alignment marks.

5. The opto-electric hybrid board according to claim 4,
wherein the optical waveguide includes a plurality of mirrors, and a plurality of exit surfaces of light are present in the first surface of the electric circuit board, and
wherein the alignment marks are formed in an arrangement such that a distance between the midpoint of an imaginary straight line connecting the area centroids of the respective exit surfaces of light and the midpoint of an imaginary straight line connecting the area centroids of the respective alignment marks is within 5 mm.

6. The opto-electric hybrid board according to claim 1,
wherein the optical waveguide includes mirrors on both sides including a first mirror and a second mirror.

7. An optical-element-mounted opto-electric hybrid board comprising:
an opto-electric hybrid board as recited in claim 1; and
an optical element mounted on the opto-electric hybrid board.

8. A method of manufacturing an optical-element-mounted opto-electric hybrid board, comprising the steps of:
preparing an opto-electric hybrid board as recited in claim 1;
causing light to enter the optical waveguide of the opto-electric hybrid board to store the position of the exit surface of light in a computer, based on the alignment mark of the opto-electric hybrid board; and
mounting an optical element on the exit surface of light, based on information stored in the computer.

9. A method of manufacturing an optical-element-mounted opto-electric hybrid board, comprising the steps of:
preparing an opto-electric hybrid board as recited in claim 6;
causing light to enter the optical waveguide from the first mirror side of the opto-electric hybrid board to store the position of an exit surface of light on the second mirror side in a computer, based on the alignment mark of the opto-electric hybrid board;
causing light to enter the optical waveguide from the second mirror side of the opto-electric hybrid board to mount an optical element on an exit surface of light on the first mirror side; and
mounting an optical element on the exit surface of light on the second mirror side, based on information stored in the computer.
